(19) United States
(12) Patent Application Publication
(10) Pub. No.: US 2025/0376212 A1
(43) Pub. Date: Dec. 11, 2025

(54) Device and Method for Coordinating Target Steering Angles of a Vehicle, Vehicle Having the Device

(71) Applicant: Robert Bosch GmbH, Stuttgart (DE)

(72) Inventors: Kerstin Heuss, Bietigheim-Bissingen (DE); Markus Uhland, Nordheim (DE)

(21) Appl. No.: 19/225,034

(22) Filed: Jun. 2, 2025

(30) Foreign Application Priority Data
Jun. 5, 2024 (DE) 10 2024 205 162.4

(51) Int. Cl. B62D 6/00; B62D 15/02

(52) U.S. Cl. CPC B62D 6/003; B62D 15/021

(57) ABSTRACT

A device is for coordinating target steering angles of a vehicle. A target value for a yaw moment, a yaw rate, or an acceleration of yaw of the vehicle is specified. A first actual steering angle is influenced by a first target steering angle. A second actual steering angle is influenced by a second target steering angle. The first target steering angle is determined as a function of the target value and of the second actual steering angle. The second target steering angle is determined as a function of the target value and of the first actual steering angle. The first target steering angle is corrected based on a specified first weighting factor. The second target steering angle is corrected based on a specified second weighting factor.

This application claims priority under 35 U.S.C. § 119 to patent application no. DE 10 2024 205 162.4, filed on Jun. 5, 2024 in Germany, the disclosure of which is incorporated herein by reference in its entirety.

### BACKGROUND

The disclosure relates to a device and method for coordinating target steering angles of a vehicle and a vehicle comprising the device.

Today, modern vehicle dynamic control systems provide the ability to use rear axle steering to influence the steering angle of the rear axle (RWS) and steer-by-wire (SbW) on the front axle. The same applies to single wheel steering. To this end, separate logic is used for SbW and RWS and single wheel steering.

### SUMMARY

A method for coordinating target steering angles of a vehicle provides that a target value for a yaw moment, a yaw rate, or an acceleration of yaw of the vehicle is specified, wherein a first actual steering angle is influenced by a first target steering angle, wherein a second actual steering angle is influenced by a second target steering angle, wherein the first target steering angle is determined as a function of the target value and of the second actual steering angle, wherein the second target steering angle is determined as a function of the target value and of the first actual steering angle, wherein the first target steering angle is corrected by means of a specified first weighting factor, wherein the second target steering angle is corrected by means of a specified second weighting factor.

The targeted coordination allows for a simple, individual weighting between the actuators of the vehicle, said actuators setting the target steering angles without changing the physical effect, i.e. the movement of the vehicle, for example. In addition, the weighting may use only one actuator if only one of the actuators is available or is to be utilized. This has the advantage that the same solution can be used for different steering concepts. For example, if in some variants of the vehicle only one actuator is available and in other vehicle variants only the other actuator is available, the same software may still be utilized with the appropriate weighting.

For a vehicle having front axle steering and rear axle steering, it may be provided that the first target steering angle and the first actual steering angle are front axle steering angles, wherein the second target steering angle and the second actual steering angle are rear axle steering angles, or that the first target steering angle and the first actual steering angle are rear axle steering angles, wherein the second target steering angle and the second actual steering angle are front axle steering angles.

For a vehicle having single wheel steering, it may be provided that the first target steering angle and the first actual steering angle are the wheel steering angle of a first wheel of the single wheel steering, wherein the second target steering angle and the second actual steering angle are the wheel steering angle of a second wheel of the single wheel steering.

For a vehicle wherein the single wheel steering comprises two individually steered wheels on a front axle and two individually steered wheels on a rear axle, it may be provided that a third actual steering angle of a third wheel is influenced by a third target steering angle, wherein a fourth actual steering angle of a fourth wheel is influenced by a fourth target steering angle, wherein the first target steering angle is determined as a function of the target value and the second actual steering angle and the third actual steering angle and the fourth actual steering angle, wherein the second target steering angle is determined as a function of the target value and the first actual steering angle and the third actual steering angle and the fourth actual steering angle, wherein the third target steering angle is determined as a function of the target value and the first actual steering angle and the second actual steering angle and the fourth actual steering angle, wherein the fourth target steering angle is determined as a function of the target value and the first actual steering angle and the second actual steering angle and the third actual steering angle, wherein the third target steering angle is corrected by means of a specified third weighting factor, wherein the fourth target steering angle is corrected by means of a specified fourth weighting factor.

For example, the weighting factors are determined or specified between zero and one, wherein a sum of the weighting factors results in one. Regardless of the weighting, a behavior of the vehicle according to the target value is thereby achieved as long as the steering angles are also implemented as expected.

It may be contemplated that the weighting factors may be determined or altered as a function of a travel time and/or as a function of a situation. This means that the weighting is adjusted situationally, e.g., as a function of the current available actuator potentials over the run time or on the situation.

It may be contemplated that the target value is determined by a driver or assistance system as a function of a driver steering angle. For example, the assistance system is a side wind assistant or a lane keeping assistant.

It may be contemplated that a model may be provided by means of which an actual value for the yaw moment, the yaw rate, or the yaw acceleration of the vehicle as a function of the actual steering angles and the target value, wherein the particular target steering angle is by means of the model inverted to calculate the particular target steering angle. Regardless of the type of model, a behavior of the vehicle according to the target value is achieved as long as the steering angle is implemented as expected and the model is selected sufficiently accurately.

For example, the model comprises a single-track model or a double-track model of the vehicle.

A device for coordinating target steering angles of a vehicle provides that the device is configured to perform the method.

A vehicle provides that the vehicle comprises the device for coordinating target steering angles of the vehicle.

### BRIEF DESCRIPTION OF THE DRAWINGS

Further advantageous embodiments will become apparent from the following description and the drawing. The drawings show:

FIG. 1 a schematic illustration of a vehicle,

FIG. 2 a block diagram of a coordination of target steering angles of the vehicle,

FIG. 3 is a flow chart showing steps of a method for coordinating target steering angles of the vehicle.

### DETAILED DESCRIPTION

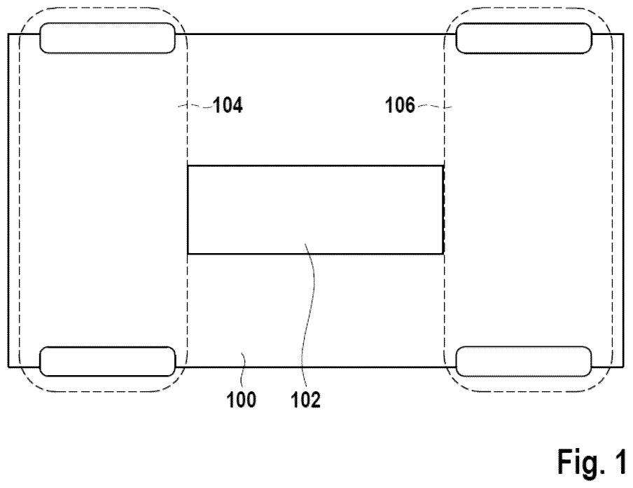

A vehicle 100 having a device 102 for coordinating target steering angles of the vehicle 100 is schematically illustrated in FIG. 1. The device 102 is configured to perform a method of coordinating target steering angles of the vehicle 100.

The device 102 is described by way of example of coordination between a first target steering angle δ_{FA}_{_{target}} for a front axle steering system 104 and a second target steering angle δ_{RA}_{_{target}} for f a rear axle steering system 106 of the vehicle 100.

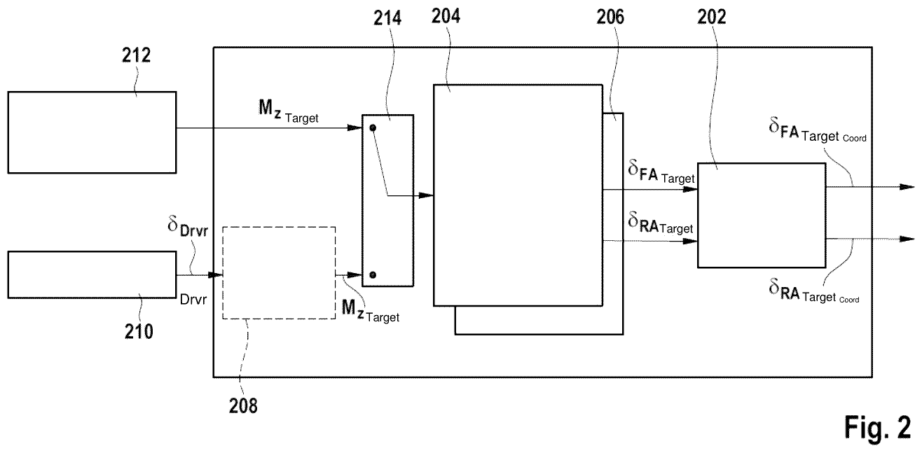

In FIG. 2, a block diagram of the coordination between the first target steering angle δ_{FA}_{_{target}} and the second target steering angle is δ_{RA}_{_{target}} shown. The block diagram schematically illustrates an exemplary construction of a portion of the device 102.

Coordination is based on a weighting 202 between the first target steering angle δ_{FA}_{_{target}} and the second target steering angle δ_{RA}_{_{target}}. As a result of the coordination, a coordinated first target steering angle δ_{FA}_{_{target,coord}} and a coordinated second target steering angle δ_{RA}_{_{target,coord}} are output.

The first target steering angle δ_{FA}_{_{target}} is determined as a function of a target value M_{Z}_{_{target}} by means of a δ_{FA}_{_{target}} first inverted vehicle model 204 after the first target steering angle.

The second target steering angle δ_{RA}_{_{target}} is determined as a function of the target value M_{Z}_{_{target}} by means of an inverted vehicle model 206 after the first target steering angle δ_{FA}_{_{target}}.

In the example, the target value M_{Z}_{_{target}} is determined by means of a driver target model 208 as a function of a driver steering angle δ_{Drur} specified by a real driver 210 or by an assistance system 212. For example, a switch 214 toggles between the target value M_{Z}_{_{target}} from the driver target model 208 and the target value M_{Z}_{_{target}} from the assistance system 212.

For example, the first inverted vehicle model 204 and the second inverted vehicle model 206 are based on a vehicle model fᵥ:

$${M}_{z} = {f}_{v} ( {δ}_{FA} , {δ}_{RA} )$$

wherein M_{z} represents the yaw torque of the vehicle about the perpendicular vehicle axis, δ_{FA} the front axle steering angle, δ_{RA} the rear axle steering angle. The vehicle model fᵥ may comprise a single-track model or a double-track model. The double-track model allows for the consideration of interference caused by different friction on the two wheels of the same axle of the vehicle.

For example, the first inverted vehicle model 204 is:

$${{δ}_{FA}}_{target} = {f}_{1 , v}^{- 1} ( {M}_{{Z}_{target}} , {δ}_{{RA}_{actual}} )$$

For example, the second inverted vehicle model 206 is:

$${δ}_{{RA}_{target}} = {f}_{1 , v}^{- 1} ( {M}_{{Z}_{target}} , {δ}_{{FA}_{actual}} )$$

wherein M_{Z}_{_{target}} represents a target yaw torque, δ_{RA}_{_{actual}} the actual steering angle of the rear axle steering system, and δ_{FA}_{_{actual}} the actual steering angle of the front axle steering system.

Instead of the yaw torque, the vehicle model fᵥ may also be based on a yaw rate or yaw acceleration for determining the yaw rate or yaw acceleration as a function of the front axle steering angle and rear axle steering angle, respectively.

For a single wheel steering system, it may be provided that the vehicle model fᵥ determines the yaw moment, the yaw rate, or the yaw acceleration as a function of the single wheel steering angles.

If inversion of a vehicle model is not possible, the model may be made invertable by simplifications (e.g.: small angle approximation), which have only minor effects and are negligible.

For example, the weighting 202 provides a first weighting factor i and a second weighting factor (1-i). For example, it is contemplated that the coordinated first target steering angle δ_{FA}_{_{target,coord}} is determined as a function of the first weighting factor i. For example, the coordinated first target steering angle δ_{FA}_{_{target,coord}} is determined as follows:

$${δ}_{{FA}_{target , coord}} = {δ}_{{FA}_{target}} * i$$

For example, it is contemplated that the coordinated second target steering angle δ_{FA}_{_{target,coord}} is determined as a function of the second weighting factor (1-i). For example, the coordinated second target steering angle δ_{RA}_{_{target,coord}} is determined as follows:

$${δ}_{{RA}_{target , coord}} = {δ}_{{RA}_{target}} * ( 1 - i )$$

That is, the yaw response of the vehicle 100 is the same regardless of the weighting factor i, (1-i) selected when the particular target steering angles are set accurately and the vehicle model fᵥ is accurate.

In the example, the weighting factors i, (1-i) between zero and one are selected.

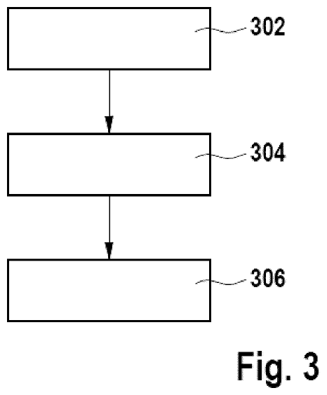

FIG. 3 shows a flow chart having steps of a method for coordinating target steering angles of the vehicle.

The method comprises a step 302.

In step 302, the target value is specified. For example, the target value is determined as a function of the driver steering angle δ_{Dru} of the driver 210 or the assistance system 212.

The method comprises a step 304.

In step 304, the target steering angles are determined.

For example, the vehicle model fᵥ is provided. For example, the target steering angles are determined by a respective inverted vehicle model.

For the coordination between front axle steering angle and rear axle steering angle, the first target steering angle is determined as a function of the target value and of the second actual steering angle. For the target yaw torque M_{z}_{_{target}}, the front axle steering angle and the rear axle steering angle are determined as follows, for example:

$${δ}_{{FA}_{target}} = {f}_{1 , v}^{- 1} ( {M}_{{Z}_{target}} , {δ}_{{RA}_{actual}} )$$

$${δ}_{{RA}_{target}} = {f}_{1 , v}^{- 1} ( {M}_{{Z}_{target}} , {δ}_{{FA}_{actual}} )$$

For the coordination between front axle steering angle and rear axle steering angle, the second target steering angle is determined as a function of the target value and the first actual steering angle.

For the coordination between individual wheel steering angles of the single wheel steering system, proceed accordingly.

This is described, by way of example, for two individually steered wheels on a front axle and two individually steered wheels on a rear axle:

For the single wheel steering,

a first actual steering angle of a first wheel is influenced by a first target steering angle, a second actual steering angle of a second wheel is influenced by a second target steering angle, a third actual steering angle of a third wheel is influenced by a third target steering angle, a fourth actual steering angle of a fourth wheel is influenced by a fourth target steering angle.

The first target steering angle is determined as a function of the target value and of the second actual steering angle and of the third actual steering angle and of the fourth actual steering angle.

The second target steering angle is determined as a function of the target value and of the first actual steering angle and the of third actual steering angle and of the fourth actual steering angle.

The third target steering angle is determined as a function of the target value and of the first actual steering angle and of the second actual steering angle and of the fourth actual steering angle.

The fourth target steering angle is determined as a function of the target value and of the first actual steering angle and of the second actual steering angle and of the third actual steering angle.

The method comprises a step 306.

In step 306, the target steering angles are corrected.

For the coordination between front axle steering angle and rear axle steering angle, the first target steering angle δ_{FA}_{_{target}} is corrected by means of the first weighting factor i and the second target steering angle δ_{RA}_{_{target}} by means of the second weighting factor (1-i).

For the coordination between single wheel steering angles of the single wheel steering system, the first target steering angle is corrected by means of a first weighting factor, the second target steering angle is corrected by means of a second weighting factor, the third target steering angle is corrected by means of a third weighting factor, and the fourth target steering angle is corrected by means of a fourth weighting factor.

For example, the weighting factors are determined or specified between zero and one.

For example, the weighting factors are determined or specified between zero and one, such that a sum of the weighting factors results in, for example, one.

It may be contemplated that the weighting factors may be determined or altered as a function of a travel time and/or as a function of a situation.

What is claimed is:

1. A method for coordinating target steering angles of a vehicle, comprising:
specifying a target value for a yaw moment, a yaw rate, or a yaw acceleration of the vehicle, wherein a first actual steering angle is influenced by a first target steering angle, wherein a second actual steering angle is influenced by a second target steering angle;
determining the first target steering angle as a function of the target value and the second actual steering angle;
determining the second target steering angle as a function of the target value and the first actual steering angle;
correcting the first target steering angle based on a specified first weighting factor; and
correcting the second target steering angle based on a specified second weighting factor.

2. The method according to claim 1, wherein:
the first target steering angle and the first actual steering angle are front axle steering angles, and the second target steering angle and the second actual steering angle are rear axle steering angles, or
the first target steering angle and the first actual steering angle are rear axle steering angles, and the second target steering angle and the second actual steering angle are front axle steering angles.

3. The method according to claim 1, wherein:
the first target steering angle and the first actual steering angle are wheel steering angles of a first wheel of a single wheel steering system, and
the second target steering angle and the second actual steering angle are wheel steering angles of a second wheel of the single wheel steering system.

4. The method according to claim 3, wherein the single wheel steering system comprises two individually steered wheels on a front axle and two individually steered wheels on a rear axle, wherein a third actual steering angle of a third wheel is influenced by a third target steering angle, and wherein a fourth actual steering angle of a fourth wheel is influenced by a fourth target steering angle, the method further comprising:
determining the first target steering angle as a function of the target value, the second actual steering angle, the third actual steering angle, and the fourth actual steering angle;
determining the second target steering angle as a function of the target value, the first actual steering angle, the third actual steering angle, and the fourth actual steering angle;
determining the third target steering angle as a function of the target value, the first actual steering angle, the second actual steering angle, and the fourth actual steering angle;
determining the fourth target steering angle as a function of the target value, the first actual steering angle, the second actual steering angle, and the third actual steering angle;
correcting the third target steering angle based on a specified third weighting factor; and
correcting the fourth target steering angle based on a specified fourth weighting factor.

5. The method according to claim 1, wherein:
the specified first weighting factor and the specified second weighting factor are determined or specified between zero and one, and
a sum of the specified first weighting factor and the specified second weighting factor is one.

6. The method according to claim 1, wherein the specified first weighting factor and the specified second weighting factor are determined or changed as a function of a run time and/or as a function of a situation.

7. The method according to claim 1, further comprising:
determining the target value by a driver or by an assistance system of the vehicle as a function of a driver steering angle.

8. The method according to claim 1, wherein:
a model is configured to determine an actual value for a yaw torque, the yaw rate, or the yaw acceleration of the vehicle as a function of the first actual steering angle, the second actual steering angle, and the target value, and
a particular target steering angle is determined using the model inverted to calculate the particular target steering angle.

9. The method according to claim 8, wherein the model comprises a single-track model of the vehicle or a double-track model of the vehicle.

10. A device for coordinating target steering angles of a vehicle, comprising:
a controller configured to carry out the method according to claim 1.

11. A vehicle, comprising:
the device according to claim 10.
